(19) United States
(12) Patent Application Publication
(10) Pub. No.: US 2004/0015943 A1
(43) Pub. Date: Jan. 22, 2004

(54) Embedded computer system equipped with an upgradeable software library

(76) Inventor: Ying-Chou Chen, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,468

(22) Filed: Jul. 17, 2002

(51) Int. Cl. G06F 9/44; G06F 9/445

(52) U.S. Cl. 717/168; 717/174; 717/164

(57) ABSTRACT

A program system stored in a memory of a computer system uses at least one computer program and a software library. The software library has at least one first-type subroutine module that is used by the computer program and at least one second-type subroutine module that is not used by the computer program. After the software library has passed a compilation process first and then a linkage process, the processed software library is stored in the memory of the computer system. The second-type subroutine module in the processed software library is changed in a non-recoverable manner after the linkage process so that the memory required to store the second-type subroutine module is saved and can be used by the computer system for other purposes.

### BACKGROUND OF INVENTION

1. Field of the Invention

The present invention relates to a software library of a computer system. Specifically, the present invention discloses an embedded computer system equipped with an upgradeable software library to allow better use of limited memory.

2. Description of the Prior Art

The increasing computing power and versatility of embedded computer systems has brought about their rising popularity in many modern applications. In most cases, embedded computer systems are small and contain limited resources. One main concern for a developer of an embedded computer system is the memory size constraint. For this reason, methods have been created for reducing memory storage requirements of software libraries used in embedded computer systems.

Please refer to FIG. 1. FIG. 1 is a block diagram of a typical software system 10 according to the prior art. This software system 10 includes program A 12, program B 14, and a shared library 16. The shared library 16 is divided into a plurality of library modules 18. As shown, both program A 12 and program B 14 are able to simultaneously access any library module 18 in the shared library 16. By using the shared library 16, library modules 18 can be commonly used by many programs, rather than each program having its own separate library or embedded code. This helps reduce redundancy, and saves valuable memory space.

Please refer to FIG. 2. FIG. 2 is a block diagram of another software system 20 according to the prior art. The software system 20 includes a plurality of executable main programs 22 accessing a C library module 24, an X library module 26, and a Z library module 28. Each library module 24, 26, 28 is further divided into a plurality of subroutine modules 29. The main programs 22 are shown accessing the three library modules 24, 26 and 28. In order to limit the amount of memory needed for execution, the linker does not link unnecessary library modules. Unfortunately, for each library module that is accessed, the software system 20 stores the entire library module, even when not all of its subroutine modules 29 are used. This results in many unused subroutine modules 29 being stored, taking up valuable memory space.

Please refer to FIG. 3. FIG. 3 is a block diagram of a software system 30 that uses an improved linking method to decide what subroutine portions of the library need to actually be linked in to memory, according to the prior art. As an improvement over the software system 20 shown in FIG. 2, the software system 30 links in only subroutine modules that are accessed by executable programs, leaving out those that are not accessed. This provides significant savings in the memory needed to store the relevant libraries.

Software system 30 contains program A 32, program B 34, program C 36, a C library module 24, and other libraries 37. The C library module 24 is further divided into subroutine modules CA 40, CB 42, CC 44, CD 46, CE 48, CF 50, and CG 52. The linking program will determine the dependencies that each program 32, 34, 36 has on the libraries. Once these dependencies are determined, links will be established to the corresponding subroutine modules in each library. After all links have been formed, a smaller C library module 38 is created which leaves out all of the unused subroutine modules from the original C library module 24. For clarity, an example of this improved linking method is given below, as illustrated in FIG. 3.

Sub-module CA 40 is referenced by both program A 32 and program B 34. In addition, CA 40 references CD 46. Therefore, both CA 40 and CD 46 will be included in the smaller C library module 38. Likewise, sub-module CB 42 is referenced by program A 32 and program B 34, sub-module CC 44 is referenced by program B 34 and program C 36, and sub-module CG 52 is referenced by program C 36. Because CA 40, CB 42, CC 44, CD 46, and CG 52 are all referenced, they will be included in the smaller C library module 38. In contrast, subroutine modules CE 48 and CF 50 are unnecessary in this situation since they are never actually utilized. Therefore, CE 48 and CF 50 are not included in the smaller C library module 38, thus preventing unused subroutine modules from being stored in memory.

Please refer to FIG. 4. FIG. 4 is a block diagram of a software system 60 that uses the improved linking method from the software system 30 in FIG. 3 along with a remote updating procedure, according to the prior art. The remote updating procedure is used to allow program updates and library module updates in the software system 60 without any recompilation needed by the user. Without the need for the user to recompile software, remotely updating greatly simplifies the process of changing software in an embedded system.

The remote updating procedure for the software system 60 is illustrated in FIG. 4. The software system 60 has a program Pa 62, a program Pb 64, an original library 66, and an optimized library 68. The original library 66 contains subroutine modules CA 72, CB 74, CC 76, CD 78, CE 80, CF 82, and CG 84. The optimized library 68 is created using the improved linking method introduced above. For the original setup of this software system 60, only subroutine modules CA 72, CB 74, CD 78, and CG 84 were needed. Thus, the improved linking method left out three subroutine modules originally unused. The remote updating procedure is started when program Pa 62 and program Pb 64 are added or modified. Program Pa 62 now has links to subroutine modules CA 72 and CC 76 while program Pb 64 now has links to subroutine modules CD 78 and CE 80. Since subroutine modules CC 76 and CE 80 were not included in the optimized library 68 and now have links to them, the improved linking method determines they must be included in a new library 70, for instance, a run-time library in C language. The advantage of this remote updating procedure is it saves the user of the software system 60 from having to compile the software after the update has taken place.

However, when used in embedded systems, the remote updating procedure has shortcomings that limit its effectiveness and simplicity. First of all, when the new library 70 is created, every sub-module it contains has to be transmitted to the embedded device at the time of the update. The procedure does not transmit just the subroutine modules that need to be updated. For example, in FIG. 4 the remote update procedure would transmit subroutine modules CA 72, CB 74, CC 76, CD 78, CE 80, and CG 84 to the embedded device even though only CC 76 and CE 80 are being added to the new library 70 due to the update. Transmitting this extra data makes the remote updating procedure very lengthy, even for small updates.

In addition to the problem just mentioned, the remote updating procedure is unable to produce a configuration of the new library 70 with a minimum number of library subroutine modules. The problem is only new subroutine modules can be added to the new library 70 during an update. Subroutine modules that are no longer unnecessary cannot be removed from the new library 70. Using the example in FIG. 4, suppose that after the update, program Pa 62 and program Pb 64 are the only programs now running. Since these two programs only have links to CA 72, CC 76, CD 78, and CE 80, only these four subroutine modules are needed in the new library 70. Instead, CB 74 and CG 84 are still transmitted to the new library because they were part of the optimized library 68 that was used before the update. Clearly, this shortcoming is a serious problem in embedded systems with a small amount of memory. Every time an update procedure is run, the size of the new library will either grow or stay the same. This results in more and more memory being occupied needlessly by unused library subroutine modules after every update.

### SUMMARY OF INVENTION

It is therefore a primary objective of the claimed invention to provide a method for updating the software library of an embedded computer system by transmitting only subroutine modules that are needed and by reclaiming the space of the unneeded subroutine modules.

The claimed invention, briefly summarized, discloses a program system stored in a memory of a computer system. The computer system has at least one computer program and a software library. The software library has at least one first-type subroutine module and at least one second-type subroutine module. The computer program uses the first-type subroutine module and the computer program does not use the second-type subroutine module. After the software library has completed a compilation process and then a linkage process, the processed software library is stored in the memory of the computer system. In addition, the second-type subroutine module in the processed software library is changed in a non-recoverable manner after the linkage process so that the memory required to store the second-type subroutine module is saved and can be used by the computer system. When the computer program is updated at a later time to use the second-type subroutine module, the second-type subroutine module is stored in the processed software library so that the updated computer program can use both the first-type and second-type subroutine modules in the software library.

It is an advantage of the claimed invention that by transmitting only new subroutine modules that are needed for the update, the update process is simplified. In addition, the subroutine modules that are not used by programs can be changed so that their memory space can be reclaimed by the software system and used for other purposes.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a typical software system according to the prior art.

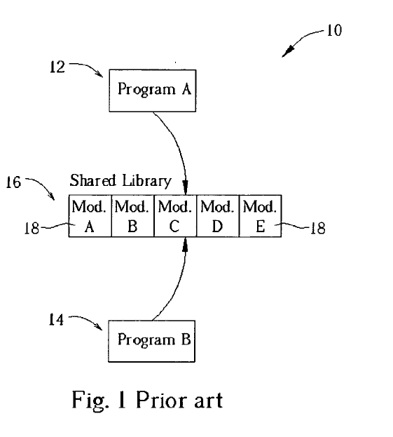

FIG. 2 is a block diagram of another software system according to the prior art.

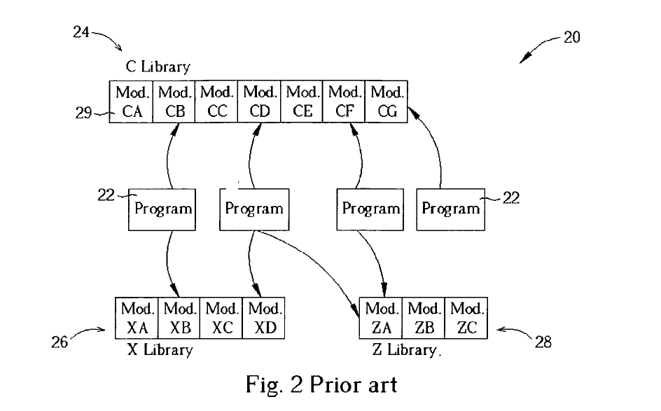

FIG. 3 is a block diagram of a software system that uses an improved linking method, according to the prior art.

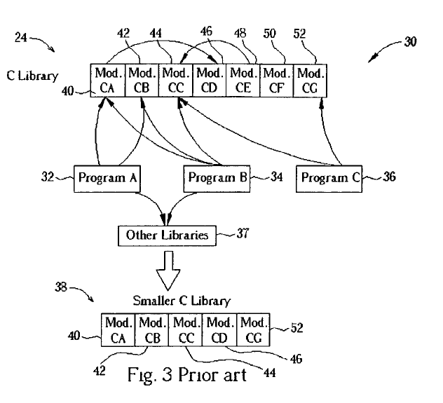

FIG. 4 is a block diagram of a software system that uses the improved linking method from the software system in FIG. 3 along with a remote updating procedure, according to the prior art.

FIG. 5 is a block diagram of a host computer that is capable of transmitting data to an embedded computer system according to the present invention.

FIG. 6 is a block diagram of the embedded computer system in an original state.

FIG. 7 is a block diagram of the embedded computer system in an updated state.

FIG. 8 is a diagram of a remote update process for the embedded computer system.

### DETAILED DESCRIPTION

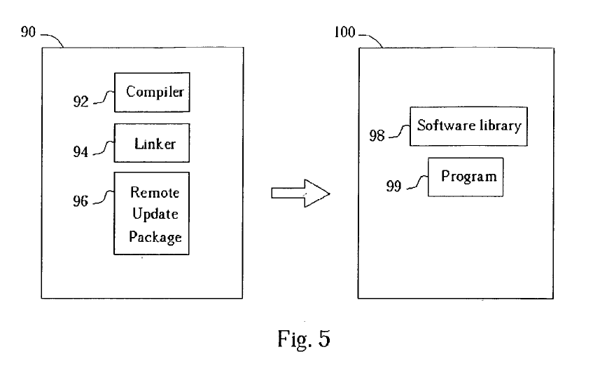

Please refer to FIG. 5. FIG. 5 is a block diagram of a host computer 90 that is capable of transmitting data to an embedded computer system 100 according to the present invention. The host computer 90 contains a compiler 92 and linker 94 that are used for generating at least one program 99 and a corresponding software library 98 on the embedded computer system 100. In addition, the host computer 90 can update the embedded computer system 100 through the use of a remote update package 96.

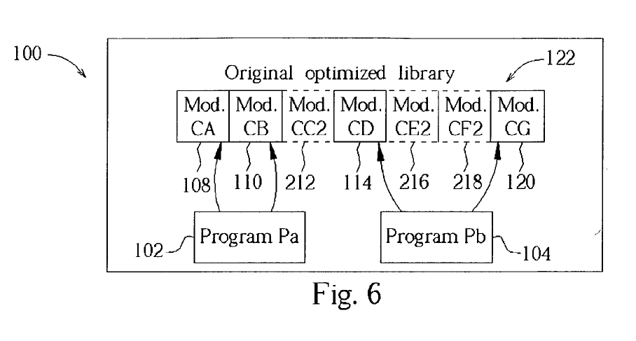

Please refer to FIG. 6. FIG. 6 is a block diagram of the embedded computer system 100 in an original state. In the original state, the embedded computer system 100 includes program Pa 102, program Pb 104, and an original optimized library 122. The original optimized library 122 is a software library created after the linker 94 on the host computer 90 determines exactly which subroutine modules from the software library are needed for the programs Pa 102 and Pb 104 that are currently running. The embedded computer system 100 includes a memory, such a flash memory, in the form of integrated circuit chips for storing the programs and the original optimized library 122.

The original optimized library 122 shown in FIG. 6 is optimized for the programs that are originally running on the embedded computer system 100, i.e., programs Pa 102 and Pb 104. In this initial setup, subroutine modules CA 108, CB 110, CD 114, and CG 120 are loaded into the original optimized library 122, and are referred to as first-type subroutine modules. First-type subroutine modules are those modules that are currently in use by at least one program. On the other hand, second-type subroutine modules are those modules that are not currently being used by any programs. In FIG. 6, subroutine modules CC2 212, CE2 216, and CF2 218 are second-type subroutine modules in the initial setup, and are denoted by a dashed line.

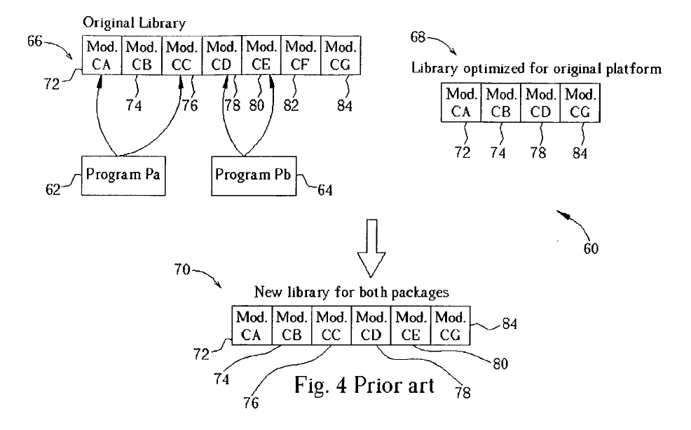

Unlike the software system 60 shown in FIG. 4, the embedded computer system 100 originally accounts for each subroutine module in the original optimized library 122 in order to simplify updating the original optimized library 122 later on. Before the embedded computer system 100 is first setup, the linker 94 on the host computer 90 determines which subroutine modules are first-type subroutine modules, and which are second-type subroutine modules. Once this information is determined, the host computer 90 then sends the original optimized library 122 to the embedded computer system 100.

In order to save space in the limited memory of the embedded computer system 100, an operating system of the embedded computer system 100 alters the second-type subroutine modules in a way that allows for maximum compression. This altering can be done in any format, such as substituting blank characters or zeroes for the second-type subroutine modules, and is done in a non-recoverable manner. Once this compression is complete, the first-type subroutine modules along with the compressed second-type subroutine modules are then stored in the memory of the embedded computer system 100. The embedded computer system 100 uses an address table to supply addresses of each subroutine module in the original optimized library 122. Thus, the embedded computer system 100 has a way of knowing exactly how to locate each subroutine module when needed in the future.

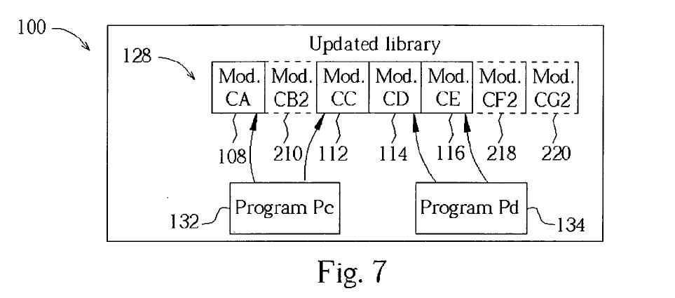

Please refer to FIG. 7. FIG. 7 is a block diagram of the embedded computer system 100 in an updated state. Program Pc 132 and program Pd 134 represent two programs that are used in the embedded computer system 100 after a remote updating procedure. Notice that program Pc 132 and program Pd 134 have links drawn to subroutine modules in an updated library 128, which is created as a result of the remote updating procedure. More specifically, program Pc 132 is linked to subroutine modules CA 108 and CC 112, and program Pd 134 is linked to subroutine modules CD 114 and CE 116. Fortunately, subroutine modules CA 108 and CD 114 are already first-type subroutine modules in the original optimized library 122, and can remain as first-type subroutine modules in the updated library 128. Likewise subroutine module CF2 218 is already a second-type subroutine module and can also remain the same in the updated library 128. All other subroutine modules, however, will need to have changes made to them to reflect their new status as a result of the update.

The first change that will have to be made is changing the first-type subroutine modules from the original optimized library 122 that will become second-type subroutine modules in the updated library 128. First-type subroutine modules CB 110 and CG 120 from the original optimized library 122 will now become second-type subroutine modules CB2 210 and CG2 220. Like before, these new second-type subroutine modules have to be altered, compressed, and stored in memory in a compressed format. This is one main advantage of the present invention since unused modules are compressed, taking up a small fraction of the memory ordinarily required.

The second change is to modify the second-type subroutine modules from the original optimized library 122 that will become first-type in the updated library 128. In this example, subroutine modules CC2 212 and CE2 216 are second-type subroutine modules in the original optimized library 122, and will have to be changed to first-type subroutine modules CC 112 and CE 116 in the updated library 128 before programs Pc 132 and Pd 134 can use them.

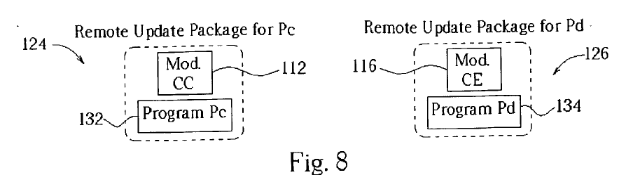

This alteration is accomplished through the remote updating procedure. Please refer to FIG. 8. FIG. 8 is a diagram of a remote update process for the embedded computer system 100. The embedded computer system 100 uses a remote update package for Pc 124 and a remote update package for Pd 126 to realize this task. As shown, the remote update package for Pc 124 contains a copy of subroutine module CC 112 and the new executable program Pc 132. Similarly, the remote update package for Pd 126 contains a copy of subroutine module CE 116 and the new executable program Pd 134. The remote updating packages 124 and 126 may also contain information about which subroutine modules are to be changed from first-type to second-type. For example, they may contain a flag to indicate that subroutine module CG 120, which is first type, is to be changed to subroutine module CG2 220, which is second type. This allows for the memory utilization of obsolete subroutine modules. The first step to converting the second-type subroutine module is to use the operating system in the embedded computer system 100 to decompress the module to restore it back to its original size. After the decompression, the second-type subroutine module is still unusable since it was earlier altered for better compression. Therefore, the subroutine module from the update package replaces the second-type subroutine module in memory, and the status of the module is changed to that of a first-type subroutine module. The main advantage of this feature is the second-type subroutine modules can be converted to first-type modules and used immediately. There is no need for another compilation and linkage process since the address table still points to the correct location of the newly converted first-type subroutine module.

As mentioned above, the operating system in the embedded computer system 100 will alter the second-type subroutine modules in a non-recoverable manner to allow for maximum compression. While this is one effective way to save memory in the computer system, another method is more suitable for operating systems such as Linux. With Linux it is possible to label blocks of memory as either available for use by the operating system or reserved by an application, referred to as the “spares file” function. The significance of this is that it is possible in some operating systems to take blocks of memory dedicated to second-type subroutine modules and release them to the operating system for other purposes rather than using the compression and decompression procedures. Note that the spares file function can be found in other operating systems or file systems. Thus, the second-type subroutine modules can be applied in other operating systems besides Linux.

FIG. 6 and FIG. 7 will be used as an illustration of this Linux memory management technique. In the original optimized library 122, the first-type subroutine modules 108, 110, 114, 120 would have their memory blocks labeled as reserved. Alternatively, the second-type subroutine modules 212, 216, and 218 would have their memory blocks labeled as available. By making memory blocks available, the operating system is releasing the memory for use by other applications, changing them in a non-recoverable manner after the release.

During the update procedure, first-type subroutine modules that will become second-type subroutine modules are released by the operating system. Conversely, second-type subroutine modules that will become first-type subroutine modules have their space reclaimed by the operating system. After the appropriate space is available, then the remote update packages replace the newly reclaimed space with a subroutine module from the original library 106. That is, subroutine modules CB 110 and CG 120 from the original optimized library 122 would be released by the operating system during the remote update procedure. On the other hand, subroutine modules CC2 212 and CE2 216 would be have their space reclaimed by the operating system, and then be replaced by subroutine modules CC 112 and CE 116 in the respective remote update packages 124, 126.

It is an advantage of the present invention that only the subroutine modules that need updating are transmitted to the embedded computer system, saving time and resources. In addition, compressing or releasing the memory of unused subroutine modules ensures that a minimum amount of memory is used to store the subroutine modules of the software library. In applications such as embedded computer systems, both of these advantages provide significant improvements when performing a remote update procedure.

Those skilled in the art will readily observe that numerous modifications and alterations of the device may be made while retaining the teachings of the invention. Accordingly, the above disclosure should be construed as limited only by metes and bounds of the appended claims.

What is claimed is:

1. A program system stored in a memory of a computer system comprising:
at least one computer program; and
a software library having at least one first-type subroutine module and at least one second-type subroutine module, where the first-type subroutine module is used by the computer program and the second-type subroutine module is not used by the computer program;
wherein after the software library has passed a compilation process first and then a linkage process, the processed software library is stored in the memory of the computer system, and the second-type subroutine module in the processed software library is changed in a non-recoverable manner after the linkage process so that the memory required to store the second-type subroutine module is saved and can be used by the computer system, and when the computer program is updated later on to use the second-type subroutine module, the second-type subroutine module is stored to the processed software library so that the updated computer program can use both the first-type and second-type subroutine modules in the software library.

2. The program system of claim 1 wherein when storing the second-type subroutine module to the software library when updating the computer program, the first-type subroutine module can be changed in a non-recoverable manner and the second-type subroutine module stored to the software library can be used by the updated computer program directly without undergoing another compilation and linkage process first.

3. The program system of claim 1 comprising a plurality of computer programs and the software library comprising a plurality of first-type subroutine modules wherein each of the first-type subroutine modules is used by at least one computer program and the second-type subroutine module is not used by any of the computer programs.

4. The program system of claim 1 wherein the second-type subroutine module is changed to an easy-compression format in a non-recoverable manner after the linkage process, and the changed second-type subroutine module is compressed first before storing to the memory of the computer system to save memory space.

5. The program system of claim 1 wherein the second-type subroutine module is changed to an easy-compression format in a non-recoverable manner after the linkage process, and the software library is compressed first before storing to the memory of the computer system to save memory space.

6. The program system of claim 4 wherein the software library is compressed first and the computer system comprises an operating system for controlling operations of the computer system, and when the operating system executes the compressed first-type subroutine module, it will de-compress the first-type subroutine module first.

7. The program system of claim 1 wherein the computer system comprises an operating system for controlling operations of the computer system, and the first-type and second-type subroutine modules are stored in the memory of the computer system through the operating system, and wherein the memory used by the second-type subroutine module can be released by the operating system for other purposes and the second-type subroutine module is non-recoverable after the release.

8. The program system of claim 7 wherein the operating system is a Linux system.

9. The program system of claim 1 wherein the computer system comprises an operating system for controlling operations of the computer system, and the first-type subroutine module is stored in the memory of the computer system through the operating system after the linkage process while the second-type subroutine module is not stored so as to save memory space.

10. The program system of claim 9 wherein the operating system is a Linux system.

11. The program system of claim 1 wherein the computer system is an embedded computer system and the memory is formed by using only memory IC (integrated circuit) chips.

12. A program system in an embedded system comprising:
a computer program stored in a memory of the embedded system; and
a software library having a first-type subroutine module and a second-type subroutine module, where the first-type subroutine module is used by the computer program and the second-type subroutine module is not used by the computer program;
wherein the software library after a compilation process is stored in the memory, and the second-type subroutine module in the processed software library is changed in a non-capacity manner after a linkage process so that the memory required to store the second-type subroutine module is saved and can be used by the embedded system, and when the computer program is updated later on to use the second-type subroutine module, the second-type subroutine module is stored to the processed software library so that the updated computer program can use both the first-type and second-type subroutine modules in the software library.

13. The program system of claim 12 wherein when storing the second-type subroutine module to the software library when updating the computer program, the first-type subroutine module can be changed in a non-capacity manner and the second-type subroutine module stored to the software library can be used by the updated computer program directly without undergoing another compilation and linkage process first.

14. The program system of claim 12 comprising a plurality of computer programs and the software library comprising a plurality of first-type subroutine modules wherein each of the first-type subroutine modules is used by at least one computer program and the second-type subroutine module is not used by any of the computer programs.

15. The program system of claim 12 wherein the second-type subroutine module is changed to an easy-compression format in a non-capacity manner after the linkage process, and the software library is compressed first before storing to the memory of the embedded system to save memory space.

16. The program system of claim 12 wherein the second-type subroutine module is changed to an easy-compression format in a non-capacity manner after the linkage process, and the software library is compressed first before storing to the memory of the embedded system to save memory space.

17. The program system of claim 15 wherein the software library is compressed first and the embedded system comprises an operating system for controlling operations of the computer system, and when the operating system executes the compressed first-type subroutine module, it will de-compress the first-type subroutine module first.

18. The program system of claim 12 wherein the embedded system comprises an operating system for controlling operations of the embedded system, and the first-type and second-type subroutine modules are stored in the memory of the embedded system through the operating system, and wherein the memory used by the second-type subroutine module can be released by the operating system for other purposes and the second-type subroutine module is non-recoverable after the release.

19. The program system of claim 18 wherein the operating system is a Linux system.
